(19) United States
(12) Patent Application Publication
(10) Pub. No.: US 2019/0184906 A1
(43) Pub. Date: Jun. 20, 2019

(54) Commercial Display Holder

(71) Applicant: Amir Farsio, Saratoga, CA (US)

(72) Inventor: Amir Farsio, Saratoga, CA (US)

(21) Appl. No.: 15/849,661

(22) Filed: Dec. 20, 2017

(51) Int. Cl. B60R 11/00; A63H 27/10

(52) U.S. Cl. CPC B60R 11/00; A63H 27/10; B60R 2011/004; A63H 2027/1008; B60R 2011/0064; A63H 2027/1041; B60R 2011/0057

(57) ABSTRACT

A balloon attachment vehicle apparatus comprising a base wherein said base is comprised of a top portion and a bottom portion wherein said bottom portion is comprised of one or more magnets and one or more contact absorbing pads wherein said one or more contact absorbing pads and said one or more magnets are positioned along a surface area of said bottom portion; a release handle positioned at said top portion of said base where said handle is mechanically connected to said magnet wherein rotating said handle lifts said one or more magnets away from said surface area; an attachment apparatus position on the top portion of said base comprising a connection point.

### INCORPORATION BY REFERENCE

This application claims the benefit of priority under 35 USC 119(e) to the filing date of U.S. provisional patent application No. 62/437,051, titled “Auto Display Holder,” which was filed on Dec. 20, 2016, and which is incorporated herein by reference in its entirety.

### FIELD OF THE INVENTION

The present invention generally relates to commercial display holder, and more specifically to an auto-dealership commercial display holder.

### BACKGROUND OF THE INVENTION

The use of various colorful and entertaining objects to attract the attention of customers by auto dealerships is well known. These include from colored flags to traditional helium filled latex balloons or plastic reusable balloons. Each of these methods has significant costs, requires significant labor, and is difficult to maintain.

Auto dealerships typically have balloons installed on different vehicles to highlight a particular brand, sale, etc. Helium balloons can easily float away if not secured properly. In addition, some marketed holders may cause damage to a vehicle surface or window over time. Other holders are placed inside a vehicle window for securement which requires turning on the vehicle, lowering the windows, and risking of damaging window seals or the vehicle. A suitable solution is desired.

Furthermore, Helium has spiked in prices, thus, the cost of the helium filled latex balloons also increase. Furthermore, latex balloons have a short life, and not reusable. Therefore, there is significant cost in the continuous filling and installing the balloons for an auto dealership advertisement. Labor cost is also high. It takes quite some time to tie and untie a balloon to an auto windshield wiper or mirror.

Auto dealerships have tried to use reusable balloons, either made of plastic or PVC, which have a longer life. However, installing the latex balloons throughout the dealership's parking lot using the traditional methods requires intensive labor. It also requires a comparable amount of time to maintain them. Often, within a few days the plastic balloon deflates and needs to be inflated again. This imposes significant labor costs, since each balloon assembly has to be manually detached from its holder assembly or an automobile, inflated, and, then, re-attached to its holder assembly or the automobile.

Therefore, there is a desire and need for a balloon holder assembly that reduces labor costs associated with its installation and maintenance. Thus, the assembly is easy to use, and convenient.

### OBJECT OF THE INVENTION

Accordingly, it is an object of this invention to provide a balloon holder assembly for commercial display for attachment to vehicle.

It is an object of the invention to provide a balloon holder assembly that does not require a removal of the assembly to carry out the balloon maintenance.

It is an object of the invention to provide a balloon holder assembly that does not require the use of helium to hold the balloon up.

### SUMMARY OF INVENTION

In one aspect of the invention, a balloon attachment vehicle apparatus comprising a base wherein the base is comprised of a top portion and a bottom portion wherein the bottom portion is comprised of one or more magnets and one or more contact absorbing pads wherein the one or more contact absorbing pads and the one or more magnets are positioned along a surface area of the bottom portion; a release handle positioned at the top portion of the base where the handle is mechanically connected to the magnet wherein rotating the handle lifts the one or more magnets away from the surface area; an attachment apparatus position on the top portion of the base comprising a connection point.

In one embodiment, the one or more contact absorbing pads is made of materials selected from the group consisting of rubber, silicone, plastic, neoprene. In one embodiment, the connection point is a bracket. In one embodiment, the base is square in shape wherein the one or more magnets are located in the center of the base and the one or more contact rubbers are positioned around the edges of the base. In one embodiment, the base is circular in shape wherein the one or more magnets are located in the center of the base and the contact rubber are positioned around the edges of the base. In one embodiment, a balloon holder apparatus comprising a balloon cup, a fill post for engaging a balloon at one end, a fill valve located on the fill post and an attachment apparatus to the connection point.

In one embodiment, wherein the balloon cup is in the shape of a funnel. In one embodiment, the balloon cup has a slit along the longitudinal axis of the balloon cup. In one embodiment, the slit is extended to the lip of the balloon cup. In one embodiment, the fill valve is between approximately 2 inches and approximately 10 feet away from the balloon.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 is a perspective view of an embodiment of present invention.

FIG. 2 is a perspective view of another embodiment of present invention.

FIG. 3 is a perspective view of an another embodiment of present invention.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more of the current commercial display balloon holders' portability and convenience problems. More specifically, the present invention is directed to an apparatus for holding down display balloons on a fragile surface, and allowing a convenient maintenance of the balloon without removing the balloon from the holder. Using one or more embodiments of the current invention, automobile dealers and other marketplaces needing a display holder can have a device capable of supporting balloons and other marketing tools with ease. Especially, when the businesses need a display that holds a commercial display down on a fragile surface, the current invention addresses the issue.

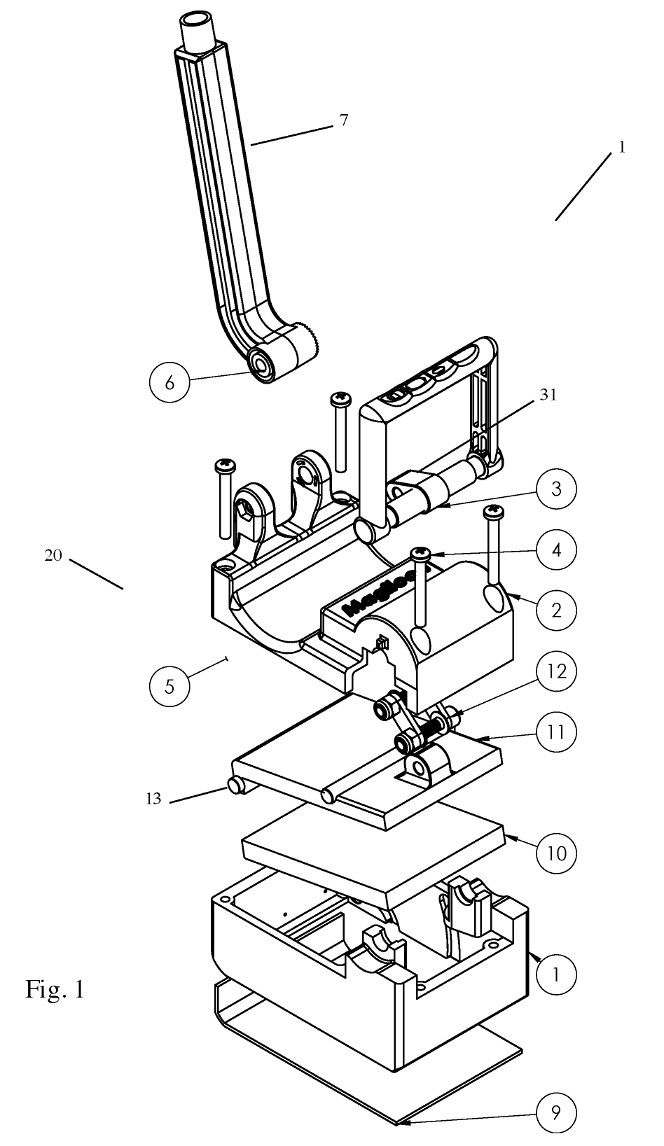

FIG. 1 shows an exploded view of one embodiment 1 of the current invention. The apparatus comprises a first handle 6 that has an elongated body comprises of a long hollow tube 7 that allows an extension connection. The first handle 6 is disposed and attached to the top 5 of a housing base 20 of the apparatus by a pin and hole pattern, similar to a door hinge. The top 5 of the housing base further comprises a second handle 3 that is attached to the top 5 at the opposite end away from the first handle 6. The second handle 3 further comprises a lever 31 that is disposed inside the housing base, under the top when the apparatus is fully assembled. The top 5 of the housing base is attached to the bottom of the housing base with screws 4. It is appreciated that the top 5 can be attached to the bottom with other attachment means. The apparatus 1 further comprises a base plate 11 that is disposed inside the housing base, and is attached to the lever 31 of the handle 3 when fully assembled. The base plate 11 is attached to the lever 31 by 2 bars linkage 12 that pivot and move up when the handle 3 is pulled up, so that it pulls the base plate 11 up and causes the base plate 11 pivoted around a hinge 13. In this manner, the base plate and the magnet, disclosed below, attached to it can be lifted away from the attached surface. The apparatus is uninstalled without causing damage to a fragile surface. At the bottom of the base plate 11, a magnet 10 is attached by a variety of adhesion methods. When in use, the magnet 10 lies flat on the bottom of the housing base 20, and provides the adhesive force so that the apparatus adheres to an auto body, commonly the roof top of an automobile, and holds down the display assembly and the balloon or other commercial display. The housing base 20 further comprises a rubber bottom 9 that protects any fragile surface the apparatus adheres to from scratches and other damages.

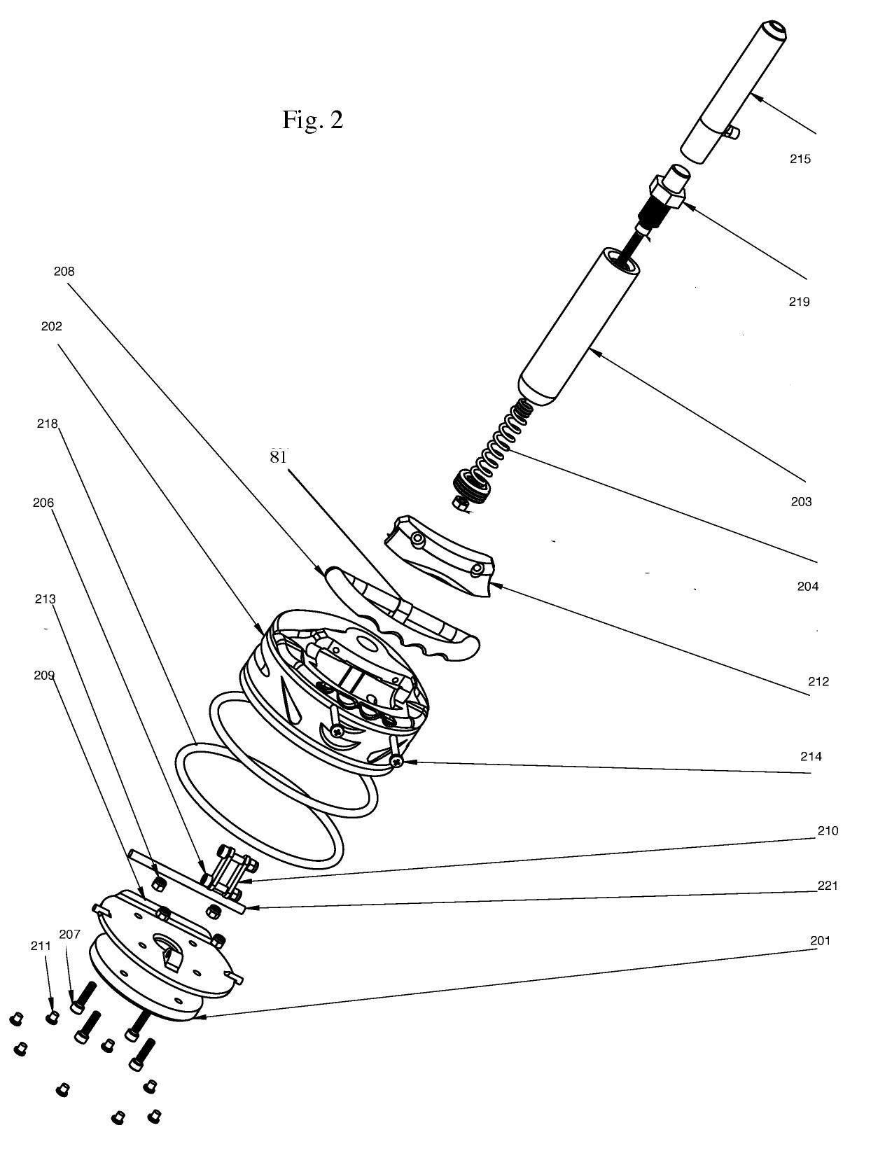

Referring to FIG. 2, another exemplary embodiment of the current invention is shown. The embodiment comprises a round-shape housing base 202 that houses levers, linkage bars, hinges, and other mechanical components of the current invention. This embodiment further comprises an elongated hollow tube 215 that allows an extension to be connected to the apparatus. The tube 215 is disposed and connected to the apparatus via a linked screw 219. The embodiment further comprises a first lever 203 that is an elongated hollow tube that allows a spring 204 is disposed within. The tube 215 and first lever 203 are both attached down to the housing base 202 on top of the housing base. Via this mechanism, an extension and a balloon or advertisement display could be attached to the apparatus when fully installed. This embodiment further comprises a cap 212 that when the apparatus is fully assembled the cap covers the mechanical parts within the housing base. The cap 212 is fastened to the housing base 202 using screws 214. This embodiment further comprises a handle 208 that is half exposed outside the housing base 202, and its covered half further comprises a lever 281 that is disposed within the housing base 202 and attached to a two-bar linkage 210 with pin and screws 206. This two-bar linkage 210 is, in turn, attached to a base plate 209 with pins and screws 206. The base plate 209 is attached to the housing base 202 with a pin 221 that allows the base plate 209 to pivot vertically. At the bottom of the base plate 209, a magnet 201 is attached with screws 207 and nuts 213. In this manner, when the base plate 209 is pivoted and lifted up the magnet 201 is also removed away the surface underneath, and, thus, the assembly is removed from the surface. This embodiment further comprises rubber O-ring base 218 that sits at the most bottom of the assembly and protects any fragile surface the current apparatus attaches to. Furthermore, for additional protection, this embodiment further comprises rubber seat 211 that are disposed around the perimeter of the housing base bottom when fully assembled to further protect the fragile surface.

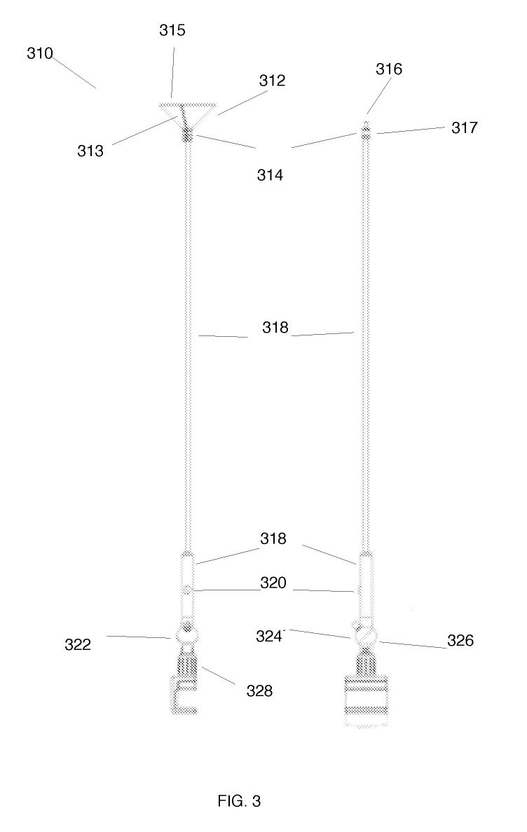

Referring to FIG. 3, the current invention accomplishes these goals by providing a Balloon Holder Assembly 310 which in one embodiment comprises of a Balloon Cup 312, a Tube Top 314, a Fill Post 318, and Filling Valve 320, and an attachment mechanism for attachment of the Balloon Holder Assembly to the base, or other objects for display. The Balloon Cup is preferably funnel shaped to hold a balloon having a balloon opening for inflation, the Balloon Cup having a lip 315. The Balloon Cup The Tube Top is preferably cylinder shaped and has two portions. A first portion 316, which is inserted into the balloon and a second portion 317, which engages the Balloon Cup and Fill Post. The inner surface area of the second portion of the Tube Top releasable engages the outer surface area of the Fill Post. The outer surface area of the second portion of the Tube Top releasable engages the inner surface area of the Balloon Cup. In another embodiment, the Balloon Holder Assembly does not require a Tube Top. In this embodiment, the Fill Post acts to replace the Tube Top and is directly inserted into the balloon opening.

The Balloon Cup 312 is preferably made of plastic and is funnel shaped. The funnel portion having a Slit 313 or longitudinal opening along the length of the funnel as shown in FIG. 1. It is understood that the opening can be of various lengths and shapes to accommodate removing and replacing the balloon, without comprising the Balloon Cup's ability to hold the balloon in an upright position. The Balloon Cup is detachable from the tube top and the Fill Post when and if the balloon needs to be replaced. This allows the funnel portion of the Cup to be opened and closed. The Fill Post 318 has a Tube Top at the top end of the Assembly 310 for attachment to the balloon. In an embodiment of the invention, the Balloon Cup is at the opposite end of the Fill Post, from the end of the Fill Post that houses the Fill Valve. The Fill Post is between approximately 2 inches and approximately 10 feet. The Fill Post is preferably between approximately 3 inches and approximately 8 feet. The Fill Post is more preferably between approximately 5 inches and approximately 36 inches. The Fill Post is ideally between approximately 8 inches and 24 inches. The Tube top 314 resides in the neck of the funnel of the Cup and is secured within the neck using traditional tie strap mechanisms. This provides for the secured holding of the balloon within the Cup 312 so that the balloon maintains continuous contact with the Tube Top 314 and is held upright after inflation.

The Fill Valve is between approximately 2 inches and approximately 10 feet away from the balloon. The Fill Valve is preferably between approximately 3 inches and approximately 8 feet away from the balloon. The Fill Valve is more preferably between approximately 5 inches and approximately 36 inches away from the balloon. The Fill Valve is ideally between approximately 8 inches and 24 inches away from the balloon.

The Airflow tube is hollow, which allows for the passage of air. The bottom end of the Fill Post contains within itself a Filling Valve 320. The Filling Valve has an opening, which prevents the escape of air and allows for insertion of an air nozzle for inflating the balloon with air.

The bottom portion of the Fill Post is attached to a Ball Mount 322, having a top portion 324 and a bottom portion 326. The top and bottom portion of the Ball Mount have internal gears, and are secured to each other using a Thumb Screw. Loosening the Thumb Screw allows for the rotation of the Fill Post around the axis of the Thumb Screw, which allows for the positioning of the balloon in a desired position.

The bottom portion of the Ball Mount is inserted and secured into a connector 328 usable to connect to the base in FIG. 1 and FIG. 2.

It is appreciated that embodiments of the current invention can be constructed using plastic and other suitable materials. It may be made in various sizes or shapes in order to accommodate all different uses and preferences.

What is claimed

1. A balloon attachment vehicle apparatus comprising a base wherein said base is comprised of a top portion and a bottom portion wherein said bottom portion is comprised of one or more magnets and one or more contact absorbing pads wherein said one or more contact absorbing pads and said one or more magnets are positioned along a surface area of said bottom portion; a release handle positioned at said top portion of said base where said handle is mechanically connected to said magnet wherein rotating said handle lifts said one or more magnets away from said surface area; an attachment apparatus position on the top portion of said base comprising a connection point.

2. The balloon attachment vehicle apparatus of claim 1 wherein said one or more contact absorbing pads is made of materials selected from the group consisting of rubber, silicone, plastic, neoprene.

3. The balloon attachment vehicle apparatus of claim 1 wherein said connection point is a bracket.

4. The balloon attachment vehicle apparatus of claim 1 wherein said base is square in shape wherein said one or more magnets are located in the center of said base and said one or more contact rubbers are positioned around the edges of said base.

5. The balloon attachment vehicle apparatus of claim 1 wherein said base is circular in shape wherein said one or more magnets are located in the center of said base and said contact rubber are positioned around the edges of said base.

6. The balloon attachment vehicle apparatus of claim 1 further comprising a balloon holder apparatus comprising a balloon cup, a fill post for engaging a balloon at one end, a fill valve located on the fill post and an attachment apparatus to said connection point.

7. The balloon attachment vehicle apparatus of claim 6 wherein said balloon cup is in the shape of a funnel.

8. The balloon attachment vehicle apparatus of claim 6 wherein said balloon cup has a slit along the longitudinal axis of the balloon cup.

9. The balloon attachment vehicle apparatus of claim 6 wherein said slit is extended to the lip of the balloon cup.

10. The balloon attachment vehicle apparatus of claim 6 wherein said fill valve is between approximately 2 inches and approximately 10 feet away from said balloon.

11. The balloon attachment vehicle apparatus of claim 6 further comprising a tube top.
